(19) United States
(12) Patent Application Publication
(10) Pub. No.: US 2013/0063296 A1
(43) Pub. Date: Mar. 14, 2013

(54) MICROWAVE ABSORBING COMPOSITION

(71) Applicants: Ingolf Hennig, Neulussheim (DE); Maxim Peretolchin, Lambrecht (DE); Hermann Bergmann, Mannheim (DE); Manivannan Ramanujachary, Heidelberg (DE); Sujandi Sujandi, Singapore (SG)

(72) Inventors: Ingolf Hennig, Neulussheim (DE); Maxim Peretolchin, Lambrecht (DE); Hermann Bergmann, Mannheim (DE); Manivannan Ramanujachary, Heidelberg (DE); Sujandi Sujandi, Singapore (SG)

(73) Assignee: BASF SE, Ludwigshafen (DE)

(21) Appl. No.: 13/572,172

(22) Filed: Aug. 10, 2012

Related U.S. Application Data
(60) Provisional application No. 61/522,267, filed on Aug. 11, 2011.

(51) Int. Cl. H01Q 17/00

(52) U.S. Cl. 342/1

(57) ABSTRACT

The present invention relates to a microwave absorbing composition comprising:
a) magnetic nanoparticles, dispersed in
b) a polymer matrix comprising at least one highly branched polymer comprising nitrogen atoms,
   a method for the production of such a microwave absorbing composition and the use thereof.

### CROSS-REFERENCE TO RELATED APPLICATIONS

This application claims the benefit of U.S. Provisional Application 61/522,267, filed Aug. 11, 2011, which is incorporated herein by reference.

### FIELD OF THE INVENTION

The invention relates to a microwave absorbing composition comprising magnetic nanoparticles dispersed in a polymer matrix.

### BACKGROUND OF THE INVENTION

Microwave absorbent materials are characterized by their ability to absorb electromagnetic energy and convert the absorbed energy into heat. In contrast to metals they do not significantly reflect incident electromagnetic microwave radiation. Those materials can be used inter alia to decrease electromagnetic interference (EMI) which affects electronic devices like computers and telecommunication systems. EMI absorbing materials can also be employed to shield cellular phone users from microwave radiation or may act as radiation absorber for controlling the radiation pattern in microwave antennae. There is an increasing demand for EMI absorbing materials in frequencies ranging from kHz to GHz.

In principle, microwave is an electromagnetic wave which consists of magnetic field and electric field perpendicular to each other propagating in space. Hence, microwave absorption property of the absorbing materials is largely determined by its inherent complex relative permittivity (εᵣ=ε′−jε″) and permeability (μᵣ=μ′−jμ″). A good microwave absorber, therefore, must be able to interact and absorb both the dielectric and magnetic field of the microwave. In other word, the real part of permittivity (ε′) and permeability (μ′) are larger than 1 and the imaginary part of permittivity (ε″) and permeability (μ″) are larger than zero. The design of an effective microwave absorber requires control over the dielectric and magnetic properties of the absorber, as the absorbed electromagnetic energy is the sum of absorbed energy by dielectric and magnetic component of the absorber.

An ideal absorber will be one that satisfies two prerequisites: (1) the impedance matching between free space and the material surface to prevent microwave being reflected, which needs the permittivity ε′ to be close to permeability μ′; and (2) absorbed incident waves as many as possible inside the absorber, which requires strong magnetic and dielectric losses. A perfect microwave absorber will be the one with large ε″ and μ″ and with ε′≈μ′. Further, it is important that the ε″ and ε′ values are not too large, to prevent increase in the conductivity of the absorber that will cause strong reflection of the incoming microwave.

It is known to use carbonyl iron powder (CIP) as filler to prepare magnetic material based microwave absorbers. However, since the carbonyl iron powder is a pure metallic magnetic material and is conductive, the effective permeability decreases at high frequencies due to eddy current losses induced by electromagnetic waves. Moreover, the electromagnetic wave only can penetrate as deep as the skin depth which is typically around 1 μm for CIP at microwave frequencies about 10 GHz.

Therefore, in order to fully utilize the volume of magnetic metallic particles for the absorption of electromagnetic waves, it is known to decrease the particle size to nanometer range or at least below the skin depth. Additionally, the eddy current loss also can be suppressed by using nanosized particles.

The microwave absorption of magnetic nanoparticles is caused by ferromagnetic resonance which is a precession of magnetization (M) around the anisotropy field. In the case of a ferromagnetic material with an uniaxial magnetic anisotropy, the direction of magnetization is restricted around the magnetic easy-axis. When an electromagnetic wave is irradiated to a ferromagnetic material, the magnetization precesses around the easy-axis and a natural resonance occurred. The ferromagnetic resonance frequency (fᵣ) is proportional to the magnetocrystalline anisotropy field (Ha), which is expressed by fᵣ=(v/2π)Hₐ, where v is the gyromagnetic ratio.

The ferromagnetic resonance is determined by a few physical parameters of the ferromagnetic nanoparticle, such as attenuation constant (α), anisotropy coefficient (K), saturation magnetization (Mₛ), and particle shape. When the diameter of the particles is in the nanometer range, the surface effects become increasingly important, affecting primarily the anisotropy coefficient and attenuation constant. The attenuation constant due to surface effects increases with decreasing diameter of the nanoparticles. In small particles with diameters of a few nanometers, the damping parameter can exceed bulk value for order of magnitude. Similarly, the surface anisotropy is inversely dependent on the diameter of particle and becomes important only at diameters below a few hundred nanometers. In nanoparticles with diameters of a few ten nanometers or less, the surface anisotropy not only significantly increases the effective anisotropy (up to two orders of magnitude), but can also induce uniaxial symmetry of effective anisotropy.

When the diameter of the magnetic particle is below a critical size (e.g. for iron 23 nm) the material shows monodomain (superparamagnetic) and no longer multidomain behavior.

Magnetic loss is caused by the damping of the precessing magnetization (M) vector. For a multidomain particle, the change of magnetization vector is generally brought about by domain wall displacements that are another physical reason for the microwave losses. Only at high magnetic fields H domain wall rotations will happen. For a single domain magnetic nanoparticle there is no movement of domain walls, the change in the magnetization vector is brought about by the entire domain spin rotation. Superparamagnetic particles show an additional magnetic loss mechanism in the MHz range (Neel relaxation).

Microwave absorbing nanocomposite materials made of magnetic and dielectric absorbers as fillers and polymeric matrix have been a focus of recent research in the field of microwave absorbers due to their important characteristics, such as lightweight, flexibility, and corrosion resistance which are highly demanded for advanced designs and applications. Known magnetic absorbers are conventional ferrites and metallic soft magnetic materials, such as Ni, Co, and Fe. Commonly used dielectric absorbers are conductive materials, such as carbon black, carbon fiber, CNT (carbon nanotubes), etc.

Proper control over the magnetic and dielectric properties of the ferromagnetic nanoparticles and the conductive material fillers in the microwave absorbing nanocomposites is necessary to reduce impedance mismatch at the front interface of the absorber to prevent microwave being reflected at the interface and at the same time increases absorption of electromagnetic wave that penetrates into the absorber. It is also important to well-disperse the fillers within the polymer matrix to avoid percolation.

U.S. Pat. No. 6,986,942 describes a microwave absorbing structure which comprises a non-conductive matrix within which are embedded a plurality of spatially-separated ferro- or ferri-magnetic particles, each of which particles has a largest dimension no greater than 100 nm.

G. Z. SHEN et al. describe in Materials Science-Poland, Vol. 28, No. 1, 2010 the preparation and microwave absorption of M type ferrite nanoparticle composites. The complex permittivity and permeability of ferrite epoxy resin composites were measured in a waveband of from 12.4-18 GHz.

Pirjo Koskela et al. describe in Advanced Powder Technology (2010), “Synthesis of cobalt nanoparticles to enhance magnetic permeability of metal-polymer composites”, doi:10.1016/j.apt.2010.09.010, the synthesis of metallic cobalt particles by hydrogen reduction in the presence of ethane. The obtained particles were coated in situ with carbon. The mean diameter of the primary cobalt particles varied only 5% from the mean value of 76 nm. Metal-polymer composites were formulated with a thermoplastic polymer ER182 (polypropylene-graft-poly(styrene-stat-divinylbenzene) from NOF Co., Japan) and the magnetic properties were measured up to 1 GHz.

### SUMMARY OF THE INVENTION

It is an object of the present invention to provide a nanocomposite microwave absorber with improved properties.

It was now surprisingly found that this object is achieved by dispersing magnetic nanoparticles in a polymer matrix comprising at least one highly branched nitrogen-containing polymer.

According to a first aspect of the present invention there is provided a microwave absorbing composition comprising:
a) magnetic nanoparticles, dispersed in
b) a polymer matrix comprising at least one highly branched polymer comprising nitrogen atoms.

According to a further aspect of the present invention there is provided a method for the preparation of a microwave absorbing composition as defined above and in the following, wherein nanoparticles a) are mixed with at least one highly branched polymer comprising nitrogen atoms b).

A further aspect of the present invention relates to the use of a microwave absorbing composition as defined above and in the following to decrease electromagnetic interference of electronic devices, in particular computers and telecommunication systems.

A further aspect of the present invention relates to the use of a microwave absorbing composition as defined above and in the following to shield cellular phone users from microwave radiation.

A further aspect of the present invention relates to the use of a microwave absorbing composition as defined above and in the following as radiation absorber for controlling the radiation pattern in microwave antennae.

### A BRIEF DESCRIPTION OF THE FIGURES

FIG. 1 shows the real part (ε′) of the relative complex permittivity (εᵣ=ε′−jε″) of the nanocomposite examples 2-2 to 2-4, 2-6 and 2-7.

FIG. 2 shows the imaginary part/dielectric loss (ε″) of the relative complex permittivity (εᵣ=ε′−jε″) of the nanocomposite examples 2-1 to 2-4, 2-6 and 2-7 and the comparative examples 3-1 and 3-2 on the basis of carbonyl iron powder (CIP).

FIG. 3 shows the nanocomposites real part (μ′) of the relative complex permeability (μᵣ=μ′−jμ″).

FIG. 4 shows the nanocomposites imaginary part/magnetic loss (μ″) of the relative complex permeability (μᵣ=μ′−jμ″).

FIGS. 5, 6, and 7 show the results for calculations reflection damping (RD) in dB of the nanocomposite samples as a single layer absorber before a metal plate of these composite materials in a way that the RD minimum was positioned at 5 GHz, 10 GHz, or 15 GHz.

### DETAILED DESCRIPTION OF THE INVENTION

The polymer compositions of the invention have at least one of the following advantageous properties:
superior absorption performance with broader frequency (1-20 GHz),
lighter area weight with less filling degree,
reduced thickness with improved flexibility with possibility to be applied as coating,
flame retardant properties,
anti-corrosion properties.

If the nanoparticles a) comprise magnetic metallic nanoparticles coated with carbon (in the following described as component a1)), at least one of the following additional advantages is achieved:
the carbon coating effectively prevents the metallic nanoparticles from oxidation,
the inherent conductive property of the carbon coating effectively increases the permittivity and dielectric loss of the microwave absorbing composition,
the microwave absorbing composition reveals better microwave absorption properties such as reflection loss and 15dB bandwidth compared to standard CIP containing materials.
a substantial weight saving in a discrete frequency absorption application can be achieved with carbon coated metallic nanoparticle-melamine-PU nanocomposites when compared with known CIP-melamine-PU composites.

### Magnetic Nanoparticles a)

“Nanoparticles” in the context of the present invention are particles with a volume-averaged particle diameter of at most 200 nm. Preferably, the volume-averaged particle diameter is at most 100 nm. A preferred particle size range is 4 to 200 nm, more preferably 5 to 100 nm, in particular 6 to 85 nm.

In a special embodiment, the volume-averaged particle diameter of the magnetic nanoparticles a) is in a range from 4 to 50 nm, especially 5 to 30 nm, in particular 6 to 15 nm. Such particles are usually superparamagnetic.

The particle size of the magnetic nanoparticles a) can be determined by the UPA (ultrafine particle analyzer) method, for example by laser light back scattering.

Suitable magnetic nanoparticles a) are distinguished by a high uniformity in regard to their size, size distribution and morphology. The particle size distribution of the magnetic nanoparticles a) is preferably monomodal (i.e. the distribution curve has one maximum).

Preferably, the fraction of particles of the magnetic nanoparticles a) having particle sizes that deviate more than 10% from the volume-averaged particle diameter preferably does not comprise more than 20% by weight, more preferably not more than 10% by weight, in particular not more than 5% by weight based on the total weight of the magnetic nanoparticles a).

A composition according to claim 1, wherein the magnetic nanoparticles a) comprise or consist of at least one magnetic material, selected from:
a1) magnetic metallic nanoparticles coated with carbon,
a2) ferromagnetic metals and metal alloys,
a3) metal oxides comprising at least one divalent and at least one trivalent metal,
a4) Co/M^{II}Fe2O₄ nanocomposites, and
a5) M-type barium hexaferrites.

a1) Magnetic Metallic Nanoparticles Coated with a Carbon Shell

According to a preferred embodiment, the magnetic nanoparticles a1) comprise or consist of particles that are at least partially coated with a single-layer carbon coating or multi-layer carbon coating. Advantageously, the carbon coating acts not only as protective layer for the metallic nanoparticle from oxidation but also acts as a dielectric absorber.

According to a preferred embodiment, the nanoparticles a1) are obtainable by a method, comprising:
I) providing a precursor material of the nanoparticles,
II) evaporating the precursor material in an inert gas stream at an elevated temperature in an evaporation zone,
III) feeding the evaporated precursor into a reaction zone and reacting in the presence of hydrogen and ethene,
IV) taking a discharge from the reaction zone and collecting the produced nanoparticles.

Preferred precursor materials of the nanoparticles are metal halides, in particular metal chlorides. Examples are CoCl₂, NiCl₂, etc.

Suitable inert gases are nitrogen, helium, neon, argon, etc.

In a suitable embodiment, the evaporation zone contains a packing of an inert material, e.g. Al₂O₃.

The temperature in the evaporation zone is preferably in the range from 400 to 1000° C., particularly preferably from 500 to 900° C.

The absolute pressure in the evaporation zone is preferably in the range from 10 mbar to 1000 mbar bar, particularly preferably from 15 to 100 mbar.

The temperature in the reaction zone is preferably in the range from 500 to 1500° C., particularly preferably from 750 to 1200° C.

The absolute pressure in the reaction zone is preferably in the range from 10 mbar to 1000 mbar, particularly preferably from 15 mbar to 100 mbar.

The particle mass concentration in the gas stream entering the reaction zone is preferably in a range from 1 to 50 g/m³, more preferably 2 to 25 g/m³.

The ethene concentration in the gas stream entering the reaction zone is preferably in a range from 0.01 to 1.5 vol. %, more preferably 0.03 to 1.0 vol. %.

The ratio of the amount of H₂ used to H₂ (stoichiometric) in the reaction is preferably in the range from 1 to 100, particularly preferably from 1.5 to 50. Here, H₂ (stoichiometric) is the amount of H2 is theoretically required for complete conversion of the precursor fed into the reaction zone into the corresponding metal.

Preferably, the gaseous stream leaving the reaction zone is diluted with further inert gas. Preferably, the further inert gas corresponds to the carrier gas. Preferably, the temperature of the further inert gas is remarkably lower than the gaseous stream leaving the reaction zone. Preferably, the temperature of the further inert gas is in a range of from 0 to 50° C. Thus, the hydrogen content of the gaseous stream leaving the reaction zone is reduced. Quenching of the gaseous stream leaving the reaction zone avoids agglomeration and/or sintering of the produced nanoparticles.

If desired, the discharge from the reaction zone can be subjected to at least one further work-up step. Such steps include, for example, further purification, preferably washing with a suitable washing medium to remove the hydrogen halides formed by the reaction. Suitable washing media are, for example water and aqueous bases. Suitable bases are e.g. NaOH, KOH, Ca(OH)₂, etc.

Preferably, at least a part of the magnetic nanoparticles a1) are coated with graphene.

A method for the synthesis of cobalt nanoparticles coated with carbon is described by Pirjo Koskela et al. in Advanced Powder Technology (2010), doi:10.1016/j.apt.2010.09.010. This method is also applicable with further magnetic metals.

A suitable method for the production of cobalt and nickel particles by hydrogen reduction is also described by J. Forsman et al., J. Nanopart. Res. 10 (2008) 745-759.

a2) Ferromagnetic Metals and Metal Alloys

The ferromagnetic metals and metal alloys a2) preferably contain at least one metal selected from Al, Ba, Bi, Ce, Cr, Co, Cu, Dy, Er, Eu, Gd, Ho, Fe, La, Lu, Mn, Mo, Nd, Ni, Nb, Pd, Pt, Pr, Pm, Sm, Sr, Tb, Tm, Ti, V, Yb and Y.

Preferably, the ferromagnetic metals and metal alloys are selected from Co, Fe, Ni, MnSb, MnBi, MnAs, Gd, Dy.

More preferably, the ferromagnetic metals and metal alloys comprise at least one metal selected from Co, Fe, Ni.

A special embodiment of metal alloys a2) are alloys comprising
at least one metal selected from Co, Fe, Ni, and
at least one metalloid component selected from B, C, Si, P, Al and mixtures thereof.

Preferably, the metal alloys a2) comprise
50 to 100 wt.-% of at least one metal selected from Co, Fe, Ni, and
0 to 50 wt.-% of at least one metalloid component selected from B, C, Si, P, Al and mixtures thereof.

More preferably, the metal alloys a2) comprise
80 to 99 wt.-% at least one metal selected from Co, Fe, Ni, and
1 to 20 wt.-% at least one metalloid component selected from B, C, Si, P, Al and mixtures thereof.

The metalloid component can be employed inter alia to lower the melting point of the metal alloy.

a3) Metal Oxides, Preferably Comprising at Least One Divalent and at Least One Trivalent Metal

A first preferred metal oxide is Fe₂O₃.

Preferred metal oxides comprising at least one divalent and at least one trivalent metal a3) are metal double oxides of the spinell type.

Preferably, component a3) comprises at least one metal oxides M^{II}M^{III}₂O₄, where M^{II} is a first metal component which comprises at least one divalent metal and M^{III} is a second metal component which comprises at least one trivalent metal. The stoichiometries of the individual metals are selected so that the mixed oxide M^{II}M^{III}₂O₄ is electrically neutral.

Preferably, component a3) comprises at least one ferrite of the formula M^{II}Fe₂O₄, where M^{II} is a metal component comprising at least one divalent metal. The divalent metal M^{II} is selected from Mn, Fe, Co, Ni, Mg, Ca, Cu, Zn, Y, V and combinations thereof. More preferably, the divalent metal M^{II} is selected from Mn, Fe, Co, Ni and combinations thereof.

More preferably, component a3) is selected from Fe₃O₄, CoFe₂O₄, ZnFe₂O₄.

In one special embodiment, component a3) comprises at least one metal oxide selected from ferrites with the general formula (M^{a}_{1-x-y}M^{b}ₓFe_{y})^{II}Fe^{III}₂O₄, wherein

M^{a} is selected from Mn, Co, Ni, Mg, Ca, Cu, Zn, Y and V,

M^{b} is selected from Zn and Cd,

x is 0.05 to 0.95,

y is 0 to 0.95,

the sum of x and y is at most 1,

and mixtures thereof.

Preferably, M^{a} is selected from Mn, Co and Ni.

Preferably, x is 0.05 to 0.95. In particular, x is 0.1 to 0.8,

Ferrites with the general formula M^{a}₁₋ₓZnₓFe₂O₄, where x is at least 0.2, preferably 0.2 to 0.8 and more particularly 0.3 to 0.5, are particularly preferred.

Also preferred are ferrites with the general formula Mn₁₋ₓM^{b}ₓFe₂O₄, where M^{b} is selected from Zn and Cd, more particularly Zn, and x is 0.2-0.5 and more particularly 0.3-0.4.

Also preferred are ferrites with the general formula Co₁₋ₓM^{b}ₓFe₂O₄, where M^{b} is selected from Zn and Cd, more particularly Zn, and x is 0.2-0.8 and more particularly 0.4-0.6.

Also preferred are ferrites with the general formula Ni₁₋ₓM^{b}ₓFe₂O₄, where M^{b} is selected from Zn and Cd, more particularly Zn, and x is 0.3-0.8 and more particularly 0.5-0.6.

Also preferred are ferrites with the general formula Li₁₋ₓZn₂ₓFe₅₋ₓO where x is 0-1, more particularly at least 0.1. One example is LiFe₅O₈.

The metal oxides a3) can be prepared by conventional methods, e.g. they are synthesized using solution chemistry at high temperature in the presence of a stabilizing agent which prevents agglomeration.

a4) Co/M^{II}Fe₂O₄ Nanocomposites

Suitable ferrites of the formula M_{II}Fe₂O₄ are those mentioned as component a3). Preferably, component a4) comprises at least one ferrite nanocomposite of the formula Co/M^{II}Fe₂O₄, where M^{II} is a metal component comprising at least one divalent metal. The divalent metal M^{II} is preferably selected from Mn, Fe, Co, Ni, Mg, Ca, Cu, Zn, Y, V and combinations thereof. More preferably, the divalent metal M^{II} is selected from Mn, Fe, Co, Ni and combinations thereof.

Also preferred is that the Co/M^{II}Fe₂O₄ nanocomposites form a core-shell structure, wherein the core comprises Co metal and the shell comprises at least one compound of the formula M^{II}Fe₂O₄.

In particular, component a4) is selected from Co/Fe₃O₄, Co/CoFe₂O₄, Co/ZnFe₂O₄.

The synthesis of Co/M^{II}Fe₂O₄ is described by Young Woo Oh et al. in the Journal of the Korean Ceramic Society, Vol. 47, No. 4, pp. 338-342, 2010, using Co/Fe₃O₄ as example. The synthesis involves a polyol process, using metal complexes, e.g. Fe and Co acetylacetonate as precursors. In an alternative embodiment, it is possible to employ metal salts and a complexing agent, e.g. trioctylphosphine. Suitable polyols are C₂-C₂₀-alkanediols, e.g. 1,2-dodecanediol, 1,2-tridecanediol, 1,2-tetradecanediol, 1,2-pentadecanediol, 1,2-hexadecanediol, etc.

a5) M-Type Barium Hexaferrites

M-type barium hexaferrite and derivatives thereof show a strong magnetic and dielectric loss at microwave frequency band.

M-type barium-hexaferrite (BaFe₁₂O₁₉) has a hexagonal crystal structure that has a relatively high effective internal field due to its inherent, strong crystalline anisotropy. Tuning of the magnetic and dielectric properties of this type of materials is possible by substituting the Fe³⁺ and Ba²⁺ at least partly with other metal atoms.

Suitable are in principle all M-type ferrites of the formula AFe₁₂O₁₉, where A is Ba, Sr, Pb and/or Ca and Me is Zn, Mn, Co, Cu, Fe(II) and/or 1/2(Li(I)+Fe(III)).

In a preferred embodiment, the magnetic nanoparticles a) are selected from:

BaFe₆ [Ti_{0.5}Mn_{0.5}]₃Oₓ,

BaFe_{5.5}[Ti_{0.5}Mn_{0.5}]_{3.5}Oₓ, or

Ba Fe₅[Ti_{0.5}Mn_{0.5}]₄Oₓ.

M-type ferrites and a method for their preparation is described e.g. in U.S. Pat. No. 4,469,669 (Hartmut Hibst, BASF SE).

Wen-Yu Zhao et al describe in J. Appl. Phys. 99, 08E909 (2006); doi:10.1063/1.2163842 nanostructural M-type barium hexaferrites synthesized by a spark plasma sintering method.

Surface Modification

The nanoparticles a2), a3), a4) and a5) may be subjected to a surface modification, in order to prevent agglomeration or coalescence of the nanoparticles and/or to guarantee ready dispersibility of the nanoparticles a) in the polymer matrix b).

In a special embodiment, the nanoparticles a2), a3), a4) and a5) are at least partially coated with a single-layer or multi-layer coating containing at least one compound with surface-active groups, selected from ionogenic surface-active groups, ionic surface-active groups, non-ionic surface-active groups or any combination thereof. The compound with surface-active groups is preferably selected from the salts of strong inorganic acids, saturated and unsaturated fatty acids and salts thereof, quaternary ammonium compounds, silanes, and mixtures thereof.

Suitable salts of strong inorganic acids are for example nitrates and perchlorates. Suitable saturated and unsaturated fatty acids are e.g. palmitic acid, margaric acid, stearic acid, isostearic acid, nonadecanoic acid, lignoceric acid, palmitoleic acid, oleic acid, linoleic acid, linolenic acid and elaeostearic acid. Suitable quaternary ammonium compounds are tetraalkyl ammonium hydroxides, for example tetramethyl ammonium hydroxide. Suitable silanes are alkyl trialkoxysilanes. DE-A-197 26 282 describes the surface modification of nanoparticles with at least two shells surrounding the particle. WO 97/38058 describes the production of nanoparticles surface-modified with silanes. The disclosures of the documents mentioned are fully included in the disclosure of the present specification.

The compound with surface-active groups is preferably employed in an amount of 0.1 to 50% by weight, more preferably from 0.5 to 40% by weight and more particularly from 1 to 30% by weight, based on the weight of the nanoparticles.

Polymer Matrix b)

It was surprisingly found that highly branched polymers comprising nitrogen atoms are particularly advantageous as polymer matrix for magnetic nanoparticles. In particular, if a melamine based resin is selected as the polymer matrix advantageous properties are obtained due to the fact that the melamine moieties interact strongly with the electric field of microwave at gigahertz frequency. This interaction is mainly caused by dipole polarization of the large amount of melamine hydrogen bonds and electronic conduction of melamine π electron cloud which absorb and convert the microwave energy to heat. Further, a melamine-based polymer matrix can impart flame retardant, corrosion protection and/or low density properties to the microwave absorbing compositions according to the invention.

The expression “highly branched polymers” refers for the purposes of this invention, quite generally, to polymers which are distinguished by a strongly branched structure and a high functionality. For the general definition of highly branched polymers, reference is also made to P. J. Flory, J. Am. Chem. Soc. 1952, 74, 2718, and H. Frey et al., Chem. Eur. J. 2000, 6, No. 14, 2499 (where they are referred to, in deviation from the definition chosen here, as “hyperbranched polymers”).

The highly branched polymers in the sense of the invention include star polymers, dendrimers, arborols, and highly branched polymers different therefrom, such as hyperbranched polymers.

Star polymers are polymers in which three or more chains extend from a center. This center may be a single atom or a group of atoms.

Dendrimers derive structurally from the star polymers, but with star branching in each of the individual chains. Dendrimers are formed starting from small molecules by means of a continually repeating reaction sequence resulting in ever higher numbers of branches, at whose ends there are in each case functional groups which, in turn, are a starting point for further branches. Hence, the number of monomer end groups grows exponentially with each reaction step, ultimately resulting in a tree structure which in the ideal case is spherical. A characteristic feature of the dendrimers is the number of reaction stages (generations) carried out for the purpose of their synthesis. On the basis of their uniform construction (in the ideal case, all of the branches comprise exactly the same number of monomer units), dendrimers are substantially monodisperse, i.e., they generally have a defined molar mass.

Both molecularly and structurally uniform highly branched polymers will also be referred to in common below as dendrimers.

“Hyperbranched polymers” in the context of this invention are highly branched polymers which, in contradistinction to the abovementioned dendrimers, are both molecularly and structurally nonuniform. They have side chains and/or side branches which differ in length and branching, and also a molar mass distribution (polydispersity).

Highly branched polymers preferably have a degree of branching (DB) per molecule of 10% to 100%, more preferably 10% to 90%, and more particularly 10% to 80%. This degree of branching, DB, is defined as

DB (%)=(T+Z)/(T+Z+L)×100, where

T is the average number of terminally attached monomer units,

Z is the average number of branch-forming monomer units,

L is the average number of linearly attached monomer units.

Dendrimers generally have a degree of branching DB of at least 99%, especially 99.9% to 100%.

Hyperbranched polymers preferably have a degree of branching DB of 10% to 95%, more preferably 25% to 90%, and more particularly 30% to 80%.

The highly branched polymers b) used according to the invention preferably have a degree of branching DB of 10% to 100%, preferably 20% to 95%, more preferably 25% to 90%, in particular 30% to 80%.

In order to achieve advantageous performance properties it is possible to use not only the structurally and molecularly uniform dendrimers, but also hyperbranched polymers. Hyperbranched polymers, however, are generally easier and hence more economic to prepare than dendrimers. Thus, for example, the preparation of the monodisperse dendrimers is complicated by the fact that, at each linking step, protective groups have to be introduced and removed again, and, before the beginning of each new growth stage, intense cleaning operations are needed, which is why dendrimers can typically be prepared only on a laboratory scale.

The highly branched polymer b) used according to the invention preferably have a weight-average molecular weight M_{w} in the range from about 400 to 100 000 g/mol, preferably 500 to 75 000 g/mol, more particularly 750 to 50 000 g/mol. The molar weight can be determined by gel permeation chromatography with a standard, such as polymethyl methacrylate.

The highly branched polymers comprising nitrogen atoms employed as component b) can be characterized by their ¹H NMR spectrum. Thus, e.g. highly branched nitrogen-containing polymers with methylol groups show characteristic peaks of the methylene protons at about 5 ppm.

The highly branched polymers comprising nitrogen atoms employed as component b) can be characterized by their IR spectrum. Thus, highly branched nitrogen-containing polymers with primary or secondary amino groups show characteristic peaks of the NH stretching vibration at about 3500 to 3300 cm⁻¹. Highly branched nitrogen-containing polymers with methylol groups show characteristic peaks of the OH stretching vibration at about 3200 cm⁻¹.

The highly branched polymers comprising nitrogen atoms can also be characterized by their nitrogen content. The nitrogen content in the polymers can be determined by means of elemental analysis. The nitrogen content, calculated as nitrogen and based on the total weight of the polymer is preferably at least 10% by weight, in particular at least 17% by weight. The nitrogen content, calculated as nitrogen and based on the total weight of the polymer is preferably ranging from 10 to 24% by weight.

In a special embodiment, the highly branched polymers comprising nitrogen atoms comprise alcoholic hydroxyl groups. Highly branched polymers b) comprising alcoholic hydroxyl groups preferably have an OH number (determined in accordance with DIN 53240) in a range of from 50 to 500 mg KOH/g polymer, more preferably of 100 to 450 mg KOH/g polymer, and very preferably of 200 to 400 mg KOH/g polymer.

Suitable highly branched polymer comprising nitrogen atoms b) and methods for their preparation are disclosed in the following documents. The teaching of those documents is incorporated herein by reference:
WO 97/02304, highly functional, highly branched polyurethanes.
EP 1 134 247 A2, high-functionality polyisocyanates and polyurethanes based thereon.
EP 1 167 413 A2, polyfunctional polyisocyanate polyadducts, in particular polyurethanes and polyurethane ureas, preferably predominantly OH-terminated.
EP 1 026 185 A1, dendritic or highly branched polyurethanes obtained by reacting diisocyanates and/or polyisocyanates with compounds containing at least two groups which are reactive toward isocyanates, wherein at least one of the reactants contains functional groups having a different reactivity compared to the other reactant so that only certain reactive groups react with one another in each reaction step.
WO 03/066702, high functionality, highly branched polyureas by reacting diisocyanates or polyisocyanates having capped NCO groups with bifunctional or polyfunctional primary and/or secondary amines.
WO 2004/101624, dendritic or hyperbranched polyurethanes and a method for their production by 1) reacting polyols which contain at least one tertiary nitrogen atom and at least two hydroxyl groups with a different reactivity to isocyanate groups, with polyisocyanates to obtain an addition product, the polyols and polyisocyanates being selected such that said addition product contains in average one isocyanate group and several hydroxyl groups, or one hydroxyl group and several isocyanate groups; 2) transforming the addition product obtained in stage 1) into a polyaddition product by an intermolecular reaction of the hydroxyl groups with isocyanate groups, said reaction can be preliminary carried out with a compound containing at least two hydroxyl, mercapto, amino or isocyanate groups; 3) if necessary, reacting the polyaddition product obtained in stage 2) with a compound containing at least two hydroxyl, mercapto, amino or isocyanate groups.
WO 2005/075541, high functionality, highly branched polyureas which comprises reacting one or more ureas with one or more amines having at least two primary and/or secondary amino groups, wherein at least one amine has at least three primary and/or secondary amino groups.
WO 2009/027186, hyperbranched polymers comprising guanidine units,
U.S. Pat. No. 3,966,665 describes a coating composition, comprising a mixture consisting of (a) methylolmelamine with at least part of its methylol groups optionally alkyl-etherified and (b) 0.1 to 1.5 equivalents, per equivalent of the methylolmelamine, of an aliphatic or alicyclic compound having at least two functional groups capable of reacting with the methylol groups or alkyl ethers thereof, and/or a precondensation product between the components (a) and (b).
U.S. Pat. No. 2,358,276 describes the production of condensation products from melamine, formaldehyde and dihydric alcohols. Preferred dihydric alcohols are glycols, in particular ethylene glycol, propylene glycol or diethylene glycol.
U.S. Pat. No. 4,271,286 describes a process for the preparation of methylolaminotriazines etherified with alkanols and having per mol of the aminotriazine, an analytically determined average of 0.6 n to 2 n preferably 0.7 to 2 n methylol groups, which are etherified to the extent of 30 to 60%, n being the number of amino groups in the aminotriazine. According to this process, an aminotriazine is warmed to a temperature of from 80 to 130° C. with 0.7 n to 3 n mols of formaldehyde, 2 n to 10 n mols alkanol or a mixture of alkanols having 1 to 8 carbon atoms, the carbon chain of which, if having more than two carbon atoms, can also be interrupted by an oxygen atom, and 0 to 5 n rinds of water, per mol of the aminotriazine, for 0.2 to 20 minutes, under elevated pressure, wherein said aminotriazine is first being heated to a temperature of 60 to 90° C. in the presence of the formaldehyde and 0 to 30% by weight of the total amount of alkanol or alkanol mixture for 1 to 30 minutes at a pH 8 to 11, whereupon the remainder of the alkanol or alkanol mixture is added and the mixture is subsequently heated to 80 to 130° C. under elevated pressure in the presence of a strong inorganic or organic acid, at a pH of 3 to 8, for 0.2 to 20 minutes.
U.S. Pat. No. 6,753,386 relates inter alia to a film-forming polyurethane polyol composition that comprises a reaction product of an n-functional isocyanate (wherein n is a number ranging from about 2 to about 5) with at least one diol or triol or mixtures thereof and a compound containing isocyanate-reactive functional groups, preferably a monofunctional alcohol or thiol. The low viscosity polyurethane polyol of this document is typically crosslinked/cured using a melamine to produce a cured coating which is highly acid etch resistant as well as having other desirable physical-mechanical properties.
GB 2258870 (A) describes rigid polyurethane foams obtained by reacting an aromatic isocyanate with a polyhydroxy containing compound, a blowing agent and optical additives, and incorporating a combination of melamine and urea into the unreacted polyhydroxy containing resin.
U.S. Pat. No. 4,626,578 describes a solvent-based thermosetting composition comprising (a) hydroxy functional epoxy ester resin of number average molecular weight (Mn) between about 1,000 and about 5,000, comprising the reaction product of diepoxide with aliphatic diol and, subsequently with monobasic fatty acid; and (b) polyfunctional, hydroxy-reactive crosslinking agent, for example, aminoplast crosslinking agent or blocked polyisocyanate crosslinking agent comprising isocyanate groups blocked by reaction with an active hydrogen bearing blocking agent.
WO 2008/148766, highly branched melamine polymers, obtainable by reacting melamine with 1.5 to 4 mol of one or several polyamines per mol of melamine in the presence of an acidic catalyst, wherein up to 25 mol % of the polyamines can have three or more primary amino groups and up to 50 mol % of the polyamines can be substituted by amines with only one primary amino group.
WO 2008/148842 teaches a method for the production of highly-branched methylol triaminotriazine ether comprising the following steps a-c). In step a), a non-etherified methylol triaminotriazine is provided, comprising on average 1 to 2 methylol groups per melamine unit as a solid, or aqueous solution containing at least 25% by weight solid content. In step b) the non-etherified methylol triaminotriazine is reacted with, per mol of methylol groups, 1 to 15 mol of a divalent alcohol A2, optionally with, in relation to the quantity of the divalent alcohol A2, 0 to 50 mol % of a monovalent alcohol A1 having 5 to 20 C atoms and/or 0 to 25 mol % of a trivalent or polyvalent alcohol A3. The reaction is preferably carried out at a pH value of 1 to 7. The temperature is preferably in a range of from 30 to 150° C. In particular, the reaction is continued until the reaction mixture attains a viscosity ranging from 2,000 to 15,000 mPas, measured at 25° C. Finally, in step c) the reaction is stopped by increasing the pH value to 7 by the addition of a base.

WO 2009/010546 teaches a method for producing uncured, highly branched methylol triamino triazine ether, comprising the following steps a)-c). In step a), a methylol triamino triazine etherified with a univalent alcohol A1 is provided, comprising in reacted form an average of 2 to 6 mol formaldehyde and 1 to 6 mol of the univalent alcohol Al per mol of melamine. In step b), the etherified methylol triamino triazine is reacted with 0.1 to 1 mol of a bivalent alcohol A2 per mol of etherified and unetherified methylol groups, optionally having 0 to 50 mol %, relative to the amount of the bivalent alcohol A2, of a univalent alcohol A1 having 5 to 20 C atoms and/or 0 to 25 mol % of a trivalent or higher-valent alcohol A3. The reaction is preferably carried out at a pH value of 0.5 to 7. The temperature is preferably in a range of from 30 to 150° C. The reaction is preferably performed under continuous removal of the alcohol Al released by the conversion, until the conversion mixture has achieved a viscosity in the range of 2000 to 75,000 mPas, measured at 23° C. Finally, in step c) the conversion is interrupted by increasing the pH to a value of 7 by adding a base.
WO 2009/080787, highly branched urea-melamine polymers, wherein urea or a urea derivative, melamine, and at least one amine are condensed, wherein said at least one amine comprises a diamine or polyamine having two primary amino groups.
WO 2011/073246, highly branched melamine-polyamine polymers, obtainable by condensing melamine and optionally a melamine derivate with at least one different amine having at least two primary amino groups and optionally also with urea and/or at least one urea derivative and/or with at least one at least difunctional diisocyanate or polyisocyanate and/or at least one carboxylic acid having at least two carboxyl groups or at least one derivative thereof, optionally quaternizing a portion of the amino groups of the polymer thereby obtained, reacting the polymer thus obtained with at least one compound capable of undergoing a condensation or addition reaction with amino groups, and optionally quaternizing at least part of the amino groups of the polymer obtained in the first step.

Preferred highly branched polymer comprising nitrogen atoms b) and methods for their preparation are disclosed in WO 2008/148842, WO 2009/010546, WO 2009/080787 and WO 2011/073246.

The aforementioned highly branched polymer comprising nitrogen atoms can be employed as component b) without any further modification. In an alternative embodiment, the aforementioned highly branched polymer is subjected to one or more subsequent reaction steps to provide a matrix polymer for the magnetic nanoparticles a). Suitable reaction steps are conversion of functional groups, chain extension, crosslinking and combinations thereof.

In a first preferred embodiment, the highly branched polymer b) comprises at least one highly branched polymer comprising at least one melamine group. In a special embodiment, the highly branched polymer b) consists of highly branched polymer comprising at least one melamine group.

In a second preferred embodiment, the highly branched polymer b) comprises at least one highly branched polyurethane polymer. In a special embodiment, the highly branched polymer b) consists of highly branched polyurethane polymers.

In a special embodiment, the highly branched polymer b) is a polymer blend comprising at least one highly branched polymer comprising at least one melamine group and at least one highly branched polyurethane polymer.

In a particular preferred embodiment, the highly branched polymer b) comprises at least one highly branched polyurethane polymer that comprises at least one melamine group.

(i) Highly Branched Polyurethane Polymers

In a first embodiment, the microwave absorbing composition according to the invention comprises at least one highly branched polyurethane polymer (i) as component b).

In the context of the present invention, the term “polyurethanes” comprises not only those polymers whose repeat units are bonded to one another via urethane groups, but very generally polymers which can be obtained by reaction of at least one polyisocyanate with at least one compound exhibiting at least one group which is reactive with regard to isocyanate groups. These include polymers whose repeat units, in addition to urethane groups, are also bonded by urea, allophanate, biuret, uretdione, amide, isocyanurate, carbodiimide, uretonimine, oxazolidone (oxazolidinone), oxadiazinetrione or iminooxadiazinedione groups (see, for example, Plastics Handbook, Saechtling, 26th edition, p. 491ff, Carl Hanser Verlag, Munich, 1995). The term “polyurethanes” comprises in particular polymers exhibiting urethane and/or urea groups.

In a preferred embodiment, the highly branched polyurethane polymers (i) are obtained by a process comprising reacting
A) at least one polyisocyanate, and
B) at least one highly branched condensation product (K) comprising groups which can react with isocyanate groups.

The groups of the highly branched condensation product (K) which can react with isocyanate groups are preferably selected from hydroxyl groups, primary amino groups, secondary amino groups, thiol groups and carboxy groups.

Suitable polyisocyanates A) are compounds having at least 2 (e.g. 2, 3, 4, 5, 6 or more than 6) NCO groups. Suitable are in principle all known aliphatic, cycloaliphatic, araliphatic and aromatic polyisocyanates.

Suitable polyisocyanates A) are chosen from tetramethylene diisocyanate, hexamethylene diisocyanate, octamethylene diisocyanate, decamethylene diisocyanate, dodecamethylene diisocyanate, tetradecamethylene diisocyanate, 2-butyl-2-ethylpentamethylene diisocyanate, 2,2,4-trimethyl-1,6-hexamethylene diisocyanate 2,4,4-trimethyl-1,6-hexamethylene diisocyanate, 2,3,3-trimethyl-1,6-hexamethylene diisocyanate, 1,4-diisocyanatocyclohexane, 1,3-diisocyanatocyclohexane, 1,2-diisocyanatocyclohexane, 4-methylcyclohexane 1,3-diisocyanate (H-TDI), 4,4′-di(isocyanatocyclohexyl)methane, 1-isocyanato-3,3,5-trimethyl-5-(isocyanatomethyl)cyclohexane (isophorone diisocyanate), 2,4-diisocyanato-1-methylcyclohexane, 2,6-diisocyanato-1-methylcyclohexane, 1,3-phenylene diisocyanate, 1,4-phenylene diisocyanate, 2,4-toluylene diisocyanate, 2,6-toluylene diisocyanate, isomer mixtures of 2,4-toluylene diisocyanate and 2,6-toluylene diisocyanate (e.g. 80% 2,4-isomer and 20% 2,6-isomer), tolidine diisocyanat, xylylene diisocyanate, tetramethylxylylene diisocyanate, 1,5-naphthylene diisocyanate, biphenyl diisocyanate, 2,4-diphenylmethane diisocyanate 4,4′-diphenylmethane diisocyanate, triphenylmethane-4,4′,4″-triisocyanate, triisocyanatotoluene, and mixtures thereof.

Additionally, it is possible to use polyisocyanates which can be prepared from the abovementioned polyisocyanates or mixtures thereof by means of linking via urethane, allophanate, urea, biuret, uretdione, amide, isocyanurate, carbodiimide, uretonimine, oxadiazinetrione or iminooxadiazinedione structures.

In a preferred embodiment, component A) comprises at least one diisocyanate with two isocyanate groups of varying reactivity. Particularly preferably, component A) comprises exclusively isophorone diisocyanate and its biurets, allophanates and/or isocyanurates. In particular, component A) consists only of isophorone diisocyanate.

For the preparation of highly branched polymers suitable as component b), it is possible to use masked (blocked) polyisocyanates. In masked or blocked polyisocyanates the isocyanate groups are reacted reversibly to form another functional group that under appropriate conditions can be converted back into the isocyanate group. Preferably, the isocyanate group is reacted with an alcohol, preferably a monoalcohol, to form a urethane group. The alcohol is generally eliminated simply during the reaction of the blocked polyisocyanate with a compound different from the blocking agent having NCO reactive groups. Blocking the isocyanate groups lowers the very high reactivity of the isocyanates and enables controlled reaction, e.g. with amino groups and hence controlled construction of polyureas.

A feature of other blocking reagents for NCO groups is that they ensure thermally reversible blocking of the isocyanate groups at temperatures of in general below 160° C. Blocking agents of this kind are generally used to modify isocyanates that find use in thermally curable one-component polyurethane systems. These blocking agents are described exhaustively for example, in Z. W. Wicks, Prog. Org. Coat. 3 (1975) 73-99 and Prog. Org. Coat. 9 (1981), 3-28, D. A. Wicks and Z. W. Wicks, Prog. Org. Coat. constituent (B) (1999), 148-172 and Prog. Org. Coat. 41 (2001), 1-83, and also in Houben-Weyl, Methoden der Organischen Chemie, Vol. XIV/2, 61 ff., Georg Thieme Verlag, Stuttgart 1963. Blocking agents of this kind are preferably selected from phenols, caprolactam, 1 H-imidazole, 2-methylimidazole, 1,2,4-triazole, 3,5-dimethylpyrazole, dialkyl malonates, acetanilide, acetone oxime, and butanone oxime.

(i-1) Highly Branched Polyurethane Polymers with Melamine Groups

Preferably, the highly branched polymer b) is selected from polyurethane polymers with melamine groups (i-1).

In a preferred embodiment, the highly branched polyurethane polymers with melamine groups (i-1) are obtained by a process comprising
a) reacting at least one melamine compound with a formaldehyde source and at least one difunctional alcohol (B) to give a condensation product (K),
b) reacting the condensation product (K) with at least one polyisocyanate (A).

Melamine Compound

Suitable melamine compounds are melamine and melamine derivatives. Suitable melamine derivatives are preferably selected from benzoguanamine, substituted melamines, melamine condensates and mixtures thereof. Suitable melamine condensates are preferably selected from melem, melem, melon and higher condensates. Melam (molecular formula C₆H₉N₁₁) is a dimeric condensation product of 2,4-diamino-6-chlor-s-triazin with melamine. Melem (molecular formula C₆H₆N₁₀) is Tri-s-triazin substituted with three amino groups (1,3,4,6,7,9,9b-Heptaazaphenalen). Melon (molecular formula C₆H₃N₉) is also a heptazin.

Preferably, in step a) melamine is employed as the at least one melamine compound.

Formaldehyde Source

Suitable formaldehyde sources are formaldehyde, formaldehyde oligomers (e.g. trioxane) and polymers of formaldehyde (e.g. paraformaldehyde). In a suitable embodiment, the formaldehyde is employed as an aqueous solution (formalin solution).

Component (B)

Suitable components (B) are aliphatic, cycloaliphatic or aromatic alcohols (B) which contain two OH groups or mixtures of two or more different alcohols (B).

Preferred difunctional alcohols (B) are selected from ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, difunctional polyetherols, and mixtures thereof.

Especially preferred difunctional alcohols (B) are selected from ethylene glycol, 1,2-propanediol, 1,3-propanediol, and mixtures thereof.

For preparing the highly branched polyurethane polymers with melamine groups (i-1) it is also possible, additionally, to use at least one alcohol (B′) different from the above-described alcohols (B).

Examples of alcohols (B′) having at least three OH groups are glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, bis(trimethylolpropane), di(pentaerythritol), di-, tri- or oligoglycerols, or sugars, such as glucose, polyetherols that have a functionality of three or more and are based on alcohols with a functionality of three or more and ethylene oxide, propylene oxide or butylene oxide. Particular preference is given to glycerol, trimethylolethane, trimethylolpropane, 1,2,4-butanetriol, pentaerythritol, and also their polyetherols based on ethylene oxide or propylene oxide, having been reacted with 1 to 20 mol of alkylene oxide per mole of at least trifunctional alcohol. For preparing the polyurethane polymers with melamine groups (i-1), alcohols (B′) having at least three OH groups are used preferably in an amount of 0 to 25 wt-%, more preferably 0.1 to 10 wt.-%, based on the total weight of alcohols (B) and (B′).

For preparing the highly branched polyurethane polymers with melamine groups (i-1), it is also possible, additionally, to use at least one monofunctional alcohol (B′). The use of monofunctional alcohols (B′) leads to a reduction of free OH groups of the condensation product (K). Suitable monofunctional alcohols (B′) comprise C₄-C₂₀ alkanols, such as n-butanol, sec-butanol, tert-butanol, cycloalkanols, such as cyclohexanol, aromatic alcohols, such as phenol, monofunctional polyetherols, and mixtures thereof. For preparing the polyurethane polymers with melamine groups (i-1), monofunctional alcohols (B′) are used preferably in an amount of 0 to 25 wt-%, more preferably 0.1 to 10 wt.-%, based on the total weight of alcohols (B) and (B′).

In a special embodiment for preparing the highly branched polyurethane polymer with melamine groups (i-1), a condensation product (K) is prepared by reacting melamine with formaldehyde and 1,2-propandiol, and the resulting condensation product (K) is reacted with isophorone diisocyanate.

The content of the nanoparticles a) is preferably from 1 to 99% by weight, more preferably from 1 to 60% by weight and most preferably from 9 to 50% by weight, based on the total weight of the microwave absorbing composition.

The content of the polymer matrix b) is preferably from 1 to 99% by weight, more preferably from 40 to 99% by weight and most preferably from 50 to 91% by weight, based on the total weight of the microwave absorbing composition.

The microwave absorbing composition comprises the nanoparticles a) dispersed in the polymer matrix b). For the preparation of microwave absorbing composition nanoparticles a) are mixed with at least one highly branched polymer comprising nitrogen atoms. Mixing is generally performed until an even and homogeneous distribution of the nanoparticles a) in the polymer matrix b) is achieved. An expert can determine the required mixing conditions by routine experiments.

Additive c)

The microwave absorbing composition according to the invention may comprise at least one additive c) different from components a) and b). The additive c) is preferably selected from pigments, fillers, dielectric absorbers, viscosity modifiers, dispersants, biocides, etc., and combinations thereof.

In a special embodiment, the microwave absorbing composition according to the invention may comprise at least one dielectric absorber as additive c). Suitable dielectric absorbers are conductive materials, e.g. carbon black, carbon fibers, carbon nanotubes (CNT), ionic liquids, etc.

Suitable ionic liquids for use as additive c) are commercially available, e.g. under the trade name Basionic® from BASF SE. Examples of commercially available ionic liquids which can be advantageously used in the process of the invention are 1-ethyl-3-methylimidazolium chloride (EMIM CI, Basionic ST 80) 1-ethyl-3-methylimidazolium methanesulfonate (EMIM CH3SO3, Basionic ST 35), 1-butyl-3-methylimidazolium chloride (BMIM CI, Basionic ST 70), 1-butyl-3-methylimidazolium methanesulfonate (BMIM CH3SO3, Basionic ST 78), methylimidazolium chloride (HMIM CI, Basionic AC 75), methylimidazolium hydrogensulfate (HMIM HSO4 Basionic AC 39), 1-ethyl-3-methylimidazolium hydrogensulfate (EMIM HSO₄ Basionic AC 25), 1-butyl-3-methylimidazolium hydrogensulfate (BMIM HSO₄ Basionic AC 28) 1-ethyl-3-methylimidazolium acetate (EMIM Acetat, Basionic BC 01), 1-butyl-3-methylimidazolium acetate (BMIM Acetat, Basionic BC 02).

Suitable ionic liquids for use as additive c)are described in J. Tang, M. Radosz, and Y. Shen, Macromolecules 2008, 41, 493-496.

The content of the dielectric absorber c) is preferably from 0 to 30% by weight, more preferably from 0.5 to 25% by weight and most preferably from 1 to 20% by weight, based on the total weight of the microwave absorbing composition.

In a first embodiment, an organic solvent is employed for the preparation of the microwave absorbing composition. The solvent may be added to the nanoparticle component a) and/or the polymer component b) prior to the mixing and/or may be added during the mixing. Suitable organic solvents include for example alcohols such as ethanol, propanol, isopropanol, butanol, glycol, diethylene glycol, alkylethers of glycols and diglycols, such as butylglycol and butyldiglycol, dialkylethers and cyclic ethers such as tetrahydrofurane, alkyl and cylcoalkylesters of aliphatic carboxylic acids, such as ethylacetate, ethylpropionate, ethylbutyrate, butylacetate, etc. and mixtures thereof. The organic solvent can be removed during or after the mixing, e.g. when the composite material is processed further.

When a solvent is employed, the usual mixing devices such as stirrers, compounders etc. can be used. In a preferred embodiment, the mixing is performed under application ultrasound energy.

In a second embodiment, the preparation of the microwave absorbing composition includes the mixing of at melt of the polymer component b) with at least one nanoparticle component a). For the mixing process principally all devices that are commonly used for mixing particulate materials into polymer melts, can be used. These include compounders, in particular single or multiple-screw compounders, as well as single or multiple-screw extruders, in particular counter-rotating double-screw extruders. Such devices and their setup are known to a skilled person, e.g. from F. Johannaber (Editor) Guide to Plastic Machinery, 3rd edition, C. Hanser Verlag, Munich 1992, pp. 278-401 (extruder) and p. 688 to 724 (mixers and compounders) [Kunststoffmaschinenführer, 3. Ausgabe, C. Hanser Verlag, Munchen 1992, p. 278-401 (Extruder) and p. 688-724 (Mischer and Kneter)].

Mixing using a polymer melt is preferably performed at a temperature range of 50 to 220° C., in particular at a range of 80 to 200° C.

After mixing a further processing step may follow, e.g. a thermal moulding, such as injection moulding, extrusion, laminating, rolling or pressing. If the employed polymer matrix is a thermoplastic matrix, the composite material can be made into any desired shape which would be advantageous for the further use of the composite material. For example, the composite material can be made into moulded parts such as sticks, pellets, flakes, or granules by injection moulding or extruding. The composite materials of the present invention can also be processed into sheets by rolling or calendering which can subsequently be laminated onto substrates. Shaped parts from the inventive composite materials can also be made by pressing fine particulate composite materials. For other applications, it has been proven advantageous to process the composite material into a powder which can then be used, for example, to cover the surface of a material.

Some specific applications in which the microwave absorbing structure may be used are as follows:

Cellular phones: A coating may be provided on the front of the phone which attenuates radiation which would normally impinge on the head.

Radio-frequency (RF) noisy electronics: As microprocessors get faster, they generate harmonics which are in the microwave range. This noise may interfere with communications or vice-versa, and an attenuative case comprising a microwave absorbing layer in accordance with the invention may be valuable for computers or processor casings.

Microwave antennae: The microwave absorber of the present invention may be used for controlling the radiation pattern in a microwave antenna.

The microwave absorbing compositions according to the invention are especially suitable as or in noise suppression sheets. Noise suppression sheets are in particular used in cellular phones.

The invention is elucidated in more detail with reference to the following, non-limiting examples.

### EXAMPLES

### I) SYNTHESIS EXAMPLES

1.) Synthesis of Fe2O3 Magnetic Nanoparticles:

5.4 g Fe(oleate)₃, 1.6 g oleylamine, 1.6 g methylmorpholine N-oxide and 30 ml octyldecene were added into a 2-neck reaction flask and magnetically stirred. The mixture was degassed and purged with nitrogen for 30 minutes. The reaction was carried out at 300° C. under nitrogen atmosphere for 15 minutes. The reaction solution was cooled to room temperature and the Fe₂O₃ nanoparticle product was precipitated and purified using a mixture of hexane/acetone (1:5) (volume ratio). The final product was separated by centrifuge and dried in air.

2.) Synthesis of CoFe₂O₄ Magnetic Nanoparticles:

0.56 g Co(oleate)₂, 1.62 g Fe(oleate)₃, 2.16 g oleylamine and 0.25 g oleic acid were added to 25 ml of octadecene and were stirred with magnetic stirrer. The mixture was heated to 200° C. under continuous nitrogen flow for 2 hours. Temperature of the reaction was increased to 280° C. for 1 hour. The reaction solution was cooled to room temperature and the CoFe₂O₄ nanoparticle product was precipitated and purified using ethanol. The final product was separated by centrifuge and dried in air.

3.) Synthesis of Co Magnetic Nanoparticles:

5.0 g Co(acetate)₂.4H₂O and 6.4 ml oleic acid were dissolved in 200 ml diphenylether and heated to 200° C. with a continuous nitrogen stream through the reaction mixture to facilitate the water evaporation from the reaction system. Then 4.46 ml trioctylphosphine was injected to the reaction mixture at 200° C. The reaction temperature was increased to 240° C. In a separate flask, a solution of 10 g 1,2-dodecanediol in 50 ml diphenylether was heated to 80° C. and degassed with nitrogen for 10 minutes. This solution was then injected into the above Co²⁺ solution at 240° C. and the heating was continued for 30 minutes under continuous nitrogen flow. During the reaction, an overhead mechanical stirrer was used to stir the solution. The reaction solution was cooled to room temperature and the Co nanoparticle product was precipitated and purified using ethanol. The final product was separated by centrifuge and dried in air.

4.) Synthesis of a Co/Fe₃O₄ Nanocomposite:

2.5 g Co(acetate)₂.4H₂O and 3.2 ml oleic acid were dissolved in 100 ml diphenylether and heated to 200° C. with a continuous nitrogen stream through the reaction mixture to facilitate the water evaporation from the reaction system. Then 2.23 ml trioctylphosphine was injected into the reaction mixture at a temperature of 200° C. The reaction temperature was increased to 240° C. In a separate flask, a solution of 5 g 1,2-dodecanediol in 25 ml diphenylether was heated to 80° C. and degassed with nitrogen for 10 minutes. This solution was then injected into the above-mentioned Co²⁺ solution at 240° C. and the heating was continued for 30 minutes under continuous nitrogen flow. During the reaction, an overhead mechanical stirrer was used to stir the solution. The reaction temperature was decreased to 200° C. and a solution of 9 g of Fe(oleate)₃, 6.2 ml of oleic acid and 5 g of 1,2-butandiol in 50 ml of octyldecene was injected. The temperature was increased to 240° C. and held for 1 hour. The reaction solution was cooled to room temperature and the Co/Fe₃O₄ nanoparticle product was precipitated and purified using ethanol. The final product was separated by using strong permanent magnet.

5.) Synthesis of a Magnetic Co Nanorod:

0.23 g of sodium hydroxide powder was dissolved in 50 ml methanol. 75 ml 1,2-butanediol was added to the solution and methanol was evaporated under reduced pressure. 2.73 g Co(laurate)₂ was dispersed in 50 ml hexane and sonicated for 5 minutes. The two mixtures were then mixed and the hexane was evaporated under reduced pressured. To the final mixture 0.039 g of RuCl₃ was added. The temperature of the reaction was slowly increased to 170° C. at a rate of 8° C./min. The reaction was carried out at 180° C. for 20 minutes. During the course of the reaction, an overhead mechanical stirrer was used. The reaction solution was cooled to room temperature and the Co nanorod product was precipitated and purified using ethanol. The final product was separated by using centrifuge.

6.) Synthesis of a Melamine-PU Polymer Matrix:

A hyperbranched melamine with polyol functionality and an OH value of 383 mg KOH/g (6.84 mmol OH/g) was polymerized with Basonat I (isophorone diisocyanate from BASF SE with an NCO value of 8.93 mmol NCO/g). The stoichiometric ratio of OH and NCO groups is 1:1. 10 g of the hyperbranched melamine was mixed with 7.7 g Basonat I in anhydrous THF and 5 drops dibutyltindilaurate were added as catalyst. The reaction was conducted under reflux at 80° C. under nitrogen atmosphere. The reaction was monitored by FTIR. After 4 hours reflux, the reaction was complete.

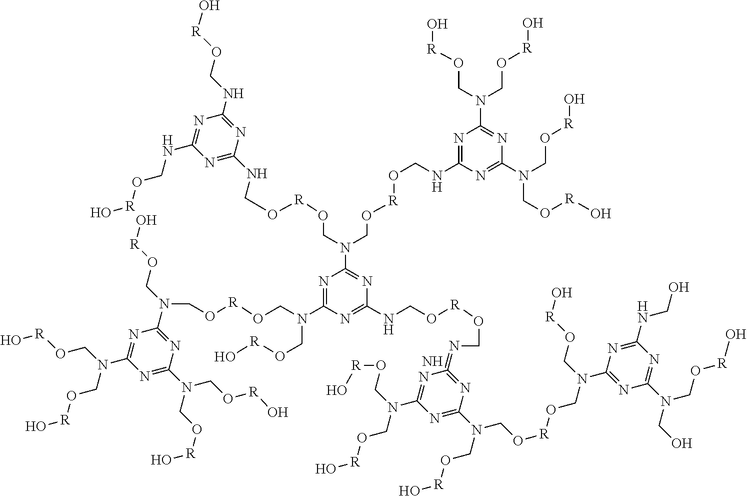

Figure: Principle structure of the hyperbranched melamine with polyol functionality

7.) Synthesis of Microwave Absorbing Compositions:

The obtained melamine-polyurethane matrix polymer was concentrated to a 50% solution (w/w) in THF. The calculated amount of the magnetic nanoparticles was added to the polymer solution and the mixture was homogenized by applying ultrasound energy (microtip) or by using Labnet VX-100 vortex mixer before being transferred to silicone mold for drying.

### II) APPLICATION EXAMPLES

Microwave Parameter Characterization:

To measure the dielectric microwave parameters (ε′: permittivity and ε″: dielectric loss) and the magnetic material parameters (μ′: permeability and μ″: magnetic loss) in the frequency range of 1 to 18 GHz, a coaxial waveguide (7 mm outer diameter, 3 mm inner diameter) was used. The samples were prepared with a thickness of about 1 mm. The measurements were done with a vectorial network analyzer HP 8510B. From the measured frequency dependent parameters the reflection damping RD in dB was calculated as a single layer absorber before a metal plate of these composite materials. RD was calculated in that way, that the RD minimum was positioned at 5 GHz, 10 GHz or 15 GHz.

Results and Discussion:

Microwave absorbing nanocomposite materials that were prepared by dispersing various magnetic nanoparticles and filling degrees in the melamine-PU resin matrix of synthesis example 6 are shown in Table 1.

Nanocomposite materials of carbon coated magnetic nanoparticle fillers and additional dielectric absorber additives (ionic liquid or carbon nanotube=CNT) in the melamine-PU resin matrix of synthesis example 6 are shown in Table 2.

Comparative carbonyl iron powder (CIP) containing composite samples with high CIP filling degrees are shown in Table 3.

TABLE 1
Microwave absorbing nanocomposite samples of various magnetic
nanoparticle with melamine-PU resin matrix.

| | | | Size | Filling % | |
|---|---|---|---|---|---|
| example no. | Magnetic nanoparticle | Shape | (nm) | (w/w) | Remark |
| 1-1 | CoFe₂O₄ | Spherical | 5 | 12 | — |
| 1-2 | γ-Fe₂O₃ | Spherical | 10 | 11 | — |
| 1-3 | Co | Spherical | 16 | 16 | — |
| 1-4 | Co/Fe₃O₄ | Spherical | 9 | 10 | — |
| | nanocomposite | | | | |
| 1-5 | Co/Fe₃O₄ | Spherical | 45 | 10 | — |
| | nanocomposite | | | | |
| 1-6 | γ-Fe₂O₃ | Spherical | 5 | 15 | — |
| 1-7 | Co | Nanorod | L = 80 | 10 | — |
| | | | W = 20 | | |
| 1-8 | CoFe₂O₄ | Spherical | 10 | 13 | — |
| 1-9 | Co | Nanorod | L = 50 | 9 | — |
| | | | W = 20 | | |
| 1-10 | CIP | NA | NA | 18 | |
| (comparative) | | | | | |
| 1-11 | MnFe₂O₄ | NA | 50 nm | 18 | |
| 1-12 | BaFe₆[Ti_{0.5}Mn_{0.5}]₃Oₓ | NA | NA | 18 | |
| 1-13 | BaFe_{5.5}[Ti_{0.5}Mn_{0.5}]_{3.5}Oₓ | NA | NA | 18 | |
| 1-14 | BaFe₅[Ti_{0.5}Mn_{0.5}]₄Oₓ | NA | NA | 18 | |
| 1-15 | Co | Nanorod | L = 80 | 40 | 1-7 with |
| | | | W = 20 | | higher filling |
| 1-16 | Co/Fe₃O₄ | Spherical | 45 | 40 | 1-5 with |
| | nanocomposite | | | | higher filling |
| 1-17 | Co | Spherical | 16 | 20 | 1-3 with |
| | | | | | higher filling |
| 1-18 | Co | Spherical | 16 | 30 | 1-3 with |
| | | | | | higher filling |
| 1-19 | Co | Spherical | 16 | 40 | 1-3 with |
| | | | | | higher filling |
| 1-20 | Co | Nanorod | L = 50 | 18 | — |
| | | | W = 20 | | |
| 1-21 | Co | Nanorod | L = 50 | 36 | — |
| | | | W = 20 | | |
| 1-22 | Co | Spherical | 50 | 36 | — |
| 1-23 | Co | Spherical | 50 | 18 | Nanoparticle |
| | | | | | annealed at |
| | | | | | 300° C. (Ar) |
| 1-24 | Co | Spherical | 50 | 18 | Nanoparticle |
| | | | | | annealed at |
| | | | | | 300° C. (95% |
| | | | | | Ar + 5% H₂) |
| 1-25 | CoFe₂O₄ | Spherical | 5 | 18 | — |
| 1-26 | CIP | NA | NA | 36 | |
| (comparative) | | | | | |
| 1-27 | CIP | NA | NA | 9 | |
| (comparative) | | | | | |
| 1-28 | Co | Nanorod | L = 50 | 18 | Nanoparticle |
| | | | W = 20 | | annealled at |
| | | | | | 530° C. |
| 1-29 | Co | Spherical | 50 | 18 | Nanoparticle |
| | | | | | annealled at |
| | | | | | 530° C. |

CIP = carbonyl iron powder

TABLE 2
Microwave absorbing nanocomposite samples of carbon
coated magnetic nanoparticle and ionic liquid and carbon
nanotube additives in melamine-PU resin matrix.

| | | | | Composition % (w/w) | | | |
|---|---|---|---|---|---|---|---|
| | Magnetic | | | | Mela- | | |
| example | nano- | | Size | Nano- | mine- | Ionic | |
| no. | particle | Shape | (nm) | particle | PU | liquid | CNT |
| 2-1 | CoC*⁾ | Spherical | ~50 | 25 | 62.5 | 12.5 | — |
| 2-2 | CoC*⁾ | Spherical | ~50 | 50 | 50 | — | — |
| 2-3 | FeC^{#)} | Spherical | 25 | 25 | 62.5 | 12.5 | — |
| | (Nabond) | | | | | | |
| 2-4 | FeC^{#)} | Spherical | 25 | 33.3 | 50 | 16 | 0.7 |
| | (Nabond) | | | | | | |
| 2-5 | FeC^{#)} | Spherical | 25 | 50 | 50 | — | — |
| | (Nabond) | | | | | | |
| 2-6 | FeC^{#)} | Spherical | 50 | 25 | 62.5 | 12.5 | — |
| | (Nabond) | | | | | | |
| 2-7 | FeC^{#)} | Spherical | 50 | 50 | 50 | — | — |
| | (Nabond) | | | | | | |

*⁾Carbon coated Co nanoparticle with particle size of approximately 50 nm were prepared according to the method disclosed by Pirjo Koskela et al. in Advanced Powder Technology (2010), “Synthesis of cobalt nanoparticles to enhance magnetic permeability of metal-polymer composites”, doi: 10.1016/j. apt. 2010.09.010.
^{#)}The carbon coated Fe nanoparticles with particle size of 25 and 50 nm, respectively, were purchased from Nabond, China (http://www.nabond.com/).

TABLE 3
Microwave absorbing composite samples of carbonyl
iron powder/CIP in melamine-PU resin matrix.

| | CIP | | Composition % (w/w) | | Composition (v/v) | |
|---|---|---|---|---|---|---|
| example | weight | Melamine- | | Melamine- | | Melamine- |
| no. | (g) | PU weight | CIP | PU | CIP | PU |
| 3-1 | 1.79 | 1 | 66 | 34 | 20 | 80 |
| 3-2 | 3.37 | 1 | 77 | 23 | 30 | 70 |

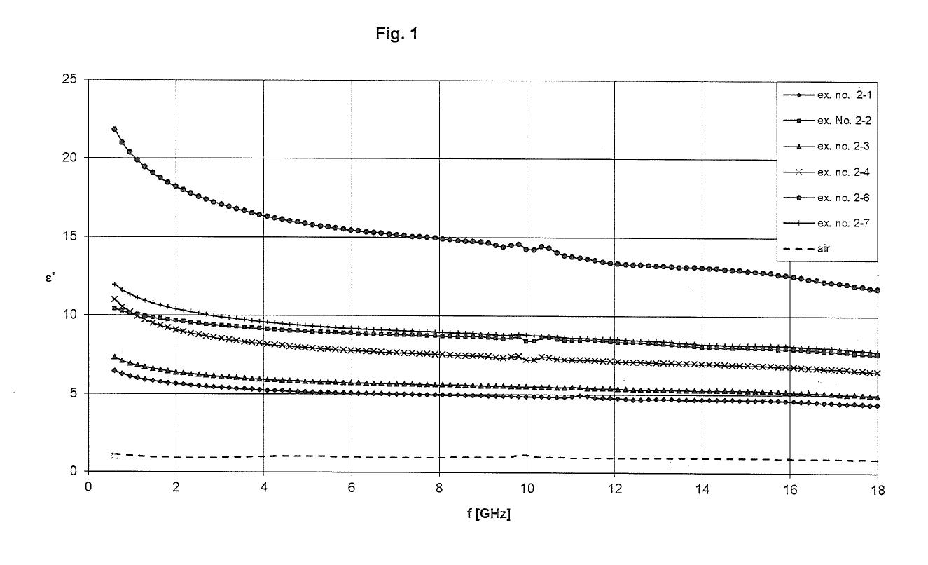

FIG. 1 shows the real part (ε′) of the relative complex permittivity (εᵣ=ε′−jε″) of the nanocomposite examples 2-2 to 2-4, 2-6 and 2-7.

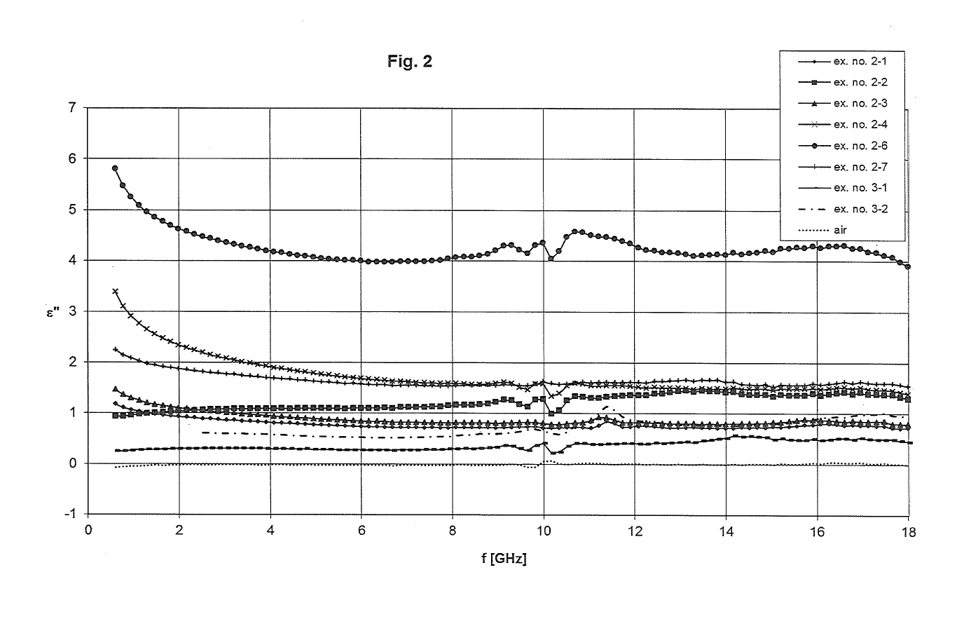

FIG. 2 shows the imaginary part/dielectric loss (ε″) of the relative complex permittivity (εᵣ=ε′−jε″) of the nanocomposite examples 2-1 to 2-4, 2-6 and 2-7 and the comparative examples 3-1 and 3-2 on the basis of carbonyl iron powder (CIP). The values of ε′ and ε″ are in the range of 5 to 20 and 0 to 5 over the frequency range of 1 to 18 GHz, respectively. The nanocomposite examples according to the invention revealed a significant higher dielectric loss value as compared to the benchmark CIP containing composite examples 3-1 and 3-2. The carbon shell coated on the Co and Fe nanoparticle seems to contribute significantly to the dielectric loss values of the nanocomposites. Further enhancement in the dielectric property was observed with addition of an ionic liquid additive as dielectric absorber.

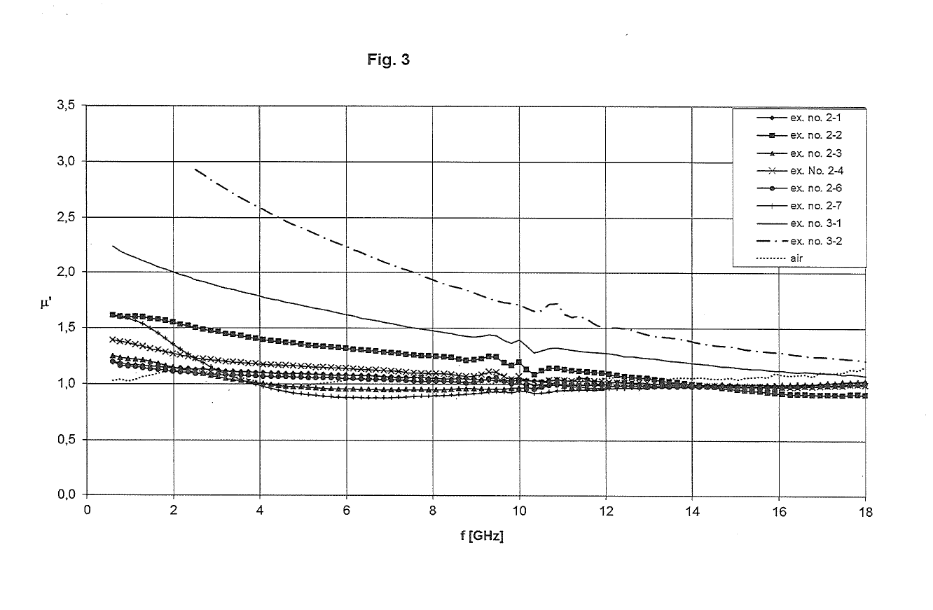

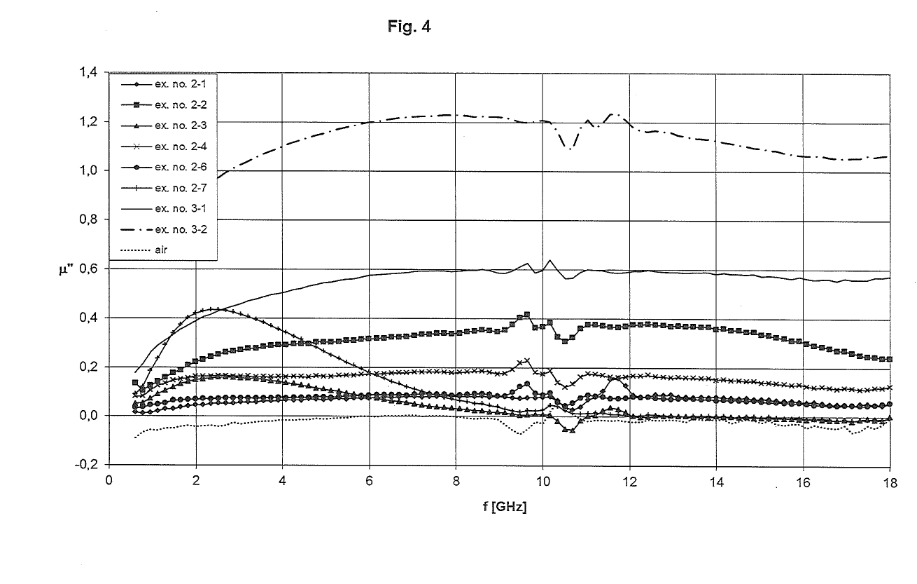

FIG. 3 shows the nanocomposites real part (μ′) of the relative complex permeability (μᵣ=μ′−jμ″). FIG. 4 shows the nanocomposites imaginary part/magnetic loss (μ″) of the relative complex permeability (μᵣ=μ′jμ″). The values are in the range of 1 to 3 at 1 GHz and the values decreases as the frequency increases to 18 GHz. The magnetic loss values μ″ are in the range of 0 to 1.2 over the frequency range of 1 to 18 GHz, respectively. In general, examples 3-1 and 3-2 which contain CIP as magnetic absorber filler showed higher magnetic permeability and magnetic loss values. Nevertheless, those higher values can be attributed to the higher degrees of filling of the CIP in those composite examples. However, the nanocomposite examples with carbon coated Co and Fe metallic nanoparticles showed relatively higher magnetic parameter values than the uncoated magnetic nanoparticles. The carbon shell coating seems to effectively protect the metallic nanoparticles from oxidation.

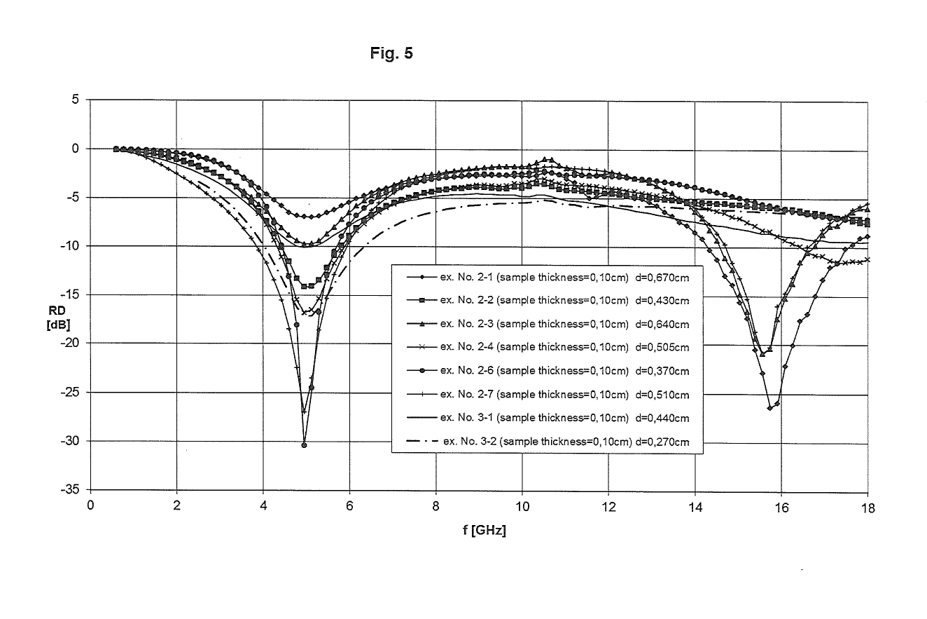

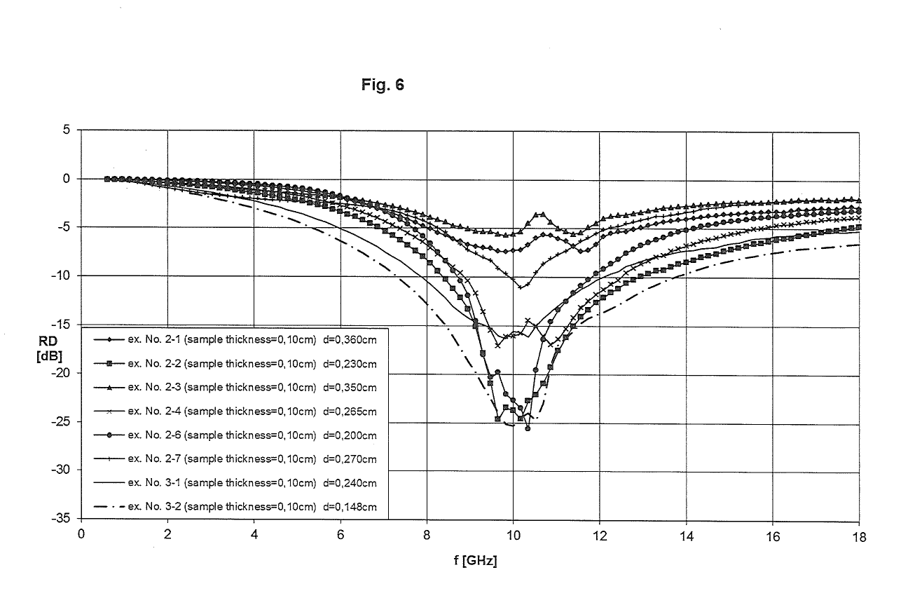

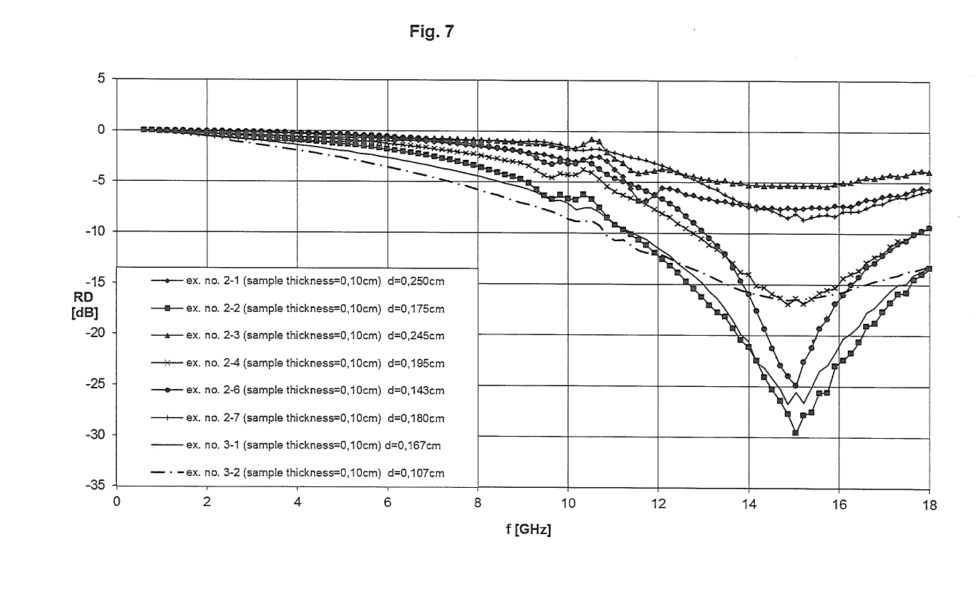

From the measured frequency dependent parameters the reflection damping RD in dB of the nanocomposite samples was calculated as a single layer absorber before a metal plate of these composite materials. RD was calculated in a way that the RD minimum was positioned at 5 GHz, 10 GHz or 15 GHz. The results are presented in FIGS. 5, 6 and 7. Example 2-6 (FeC, 25%) and Example 2-7 (FeC, 50%) showed highest microwave absorption at 5 GHz with −27 and −30 dB, respectively. The comparative CIP composite example 3-1 showed a microwave absorption at −10 dB and the comparative CIP composite example 3-2 showed a microwave absorption at −17 dB (CIP, 77%). The significant higher microwave absorption by the nanocomposite samples can be attributed to their high dielectric and magnetic loss values. At a frequency 10 GHz (FIG. 6), examples 2-2 (CoC, 50%), 2-6 (FeC, 25%) and comparative example 3-2 (CIP, 77%) exhibited similar microwave loss at −25 dB. At frequency 15 GHz (FIG. 7), example 2-2 (CoC, 50%) exhibited the highest microwave loss at −30 dB, followed by comparative example 3-2 (CIP, 66%) at −27 dB and example 2-6 (FeC, 25%) at 25 dB. As can be seen in tables 2 and 3, the filling degrees of examples 2-2 and 2-6 according to the invention are considerably lower than that of comparative examples 3-1 and 3-2. This means that the nanoparticle fillers are more effective microwave absorbing materials than standard carbonyl iron powder.

1.-15. (canceled)

16. A microwave absorbing composition comprising:
a) magnetic nanoparticles, dispersed in
b) a polymer matrix comprising at least one highly branched polymer comprising nitrogen atoms.

17. The composition according to claim 16, wherein the volume-averaged particle diameter of the magnetic nanoparticles a) is in the range from 4 to 200 nm.

18. The composition according to claim 16, wherein the volume-averaged particle diameter of the magnetic nanoparticles a) is in the range from 5 to 100 nm.

19. The composition according to claim 16, wherein the volume-averaged particle diameter of the magnetic nanoparticles a) is in the range from 6 to 85 nm.

20. The composition according to claim 16, wherein the fraction of particles of the magnetic nanoparticles a) having particle sizes that deviate more than 10% from the volume-averaged particle diameter does not exceed 20% by weight, preferably not more than 10% by weight, in particular not more than 5% by weight, based on the total weight of the magnetic nanoparticles a).

21. The composition according to claim 16, wherein the fraction of particles of the magnetic nanoparticles a) having particle sizes that deviate more than 10% from the volume-averaged particle diameter does not exceed 10% by weight.

22. The composition according to claim 16, wherein the fraction of particles of the magnetic nanoparticles a) having particle sizes that deviate more than 10% from the volume-averaged particle diameter does not exceed 5% by weight.

23. The composition according to claim 16, wherein the magnetic nanoparticles a) comprise at least one magnetic material, selected from the group consisting of:
a1) magnetic metallic nanoparticles coated with carbon,
a2) ferromagnetic metals and metal alloys,
a3) metal oxides,
a4) Co/M^{II}Fe₂O₄ nanocomposites, and
a5) M-type barium hexaferrites.

24. The composition according to claim 23, wherein the metal oxides a) comprise at least one divalent and at least one trivalent metal.

25. The composition according to claim 23, wherein the nanoparticles a1) are obtainable by a method, comprising:
I) providing a precursor material of the nanoparticles,
II) evaporating the precursor material in an inert gas stream at an elevated temperature in an evaporation zone,
III) feeding the evaporated precursor into a reaction zone and reacting in the presence of hydrogen and ethene,
IV) taking a discharge from the reaction zone and collecting the produced nanoparticles.

26. The composition according to claim 23, wherein at least a part of the magnetic nanoparticles a1) are coated with graphene.

27. The composition according to claim 23, wherein the nanoparticles a2), a3), a4) and a5) are at least partially coated with a single-layer or multi-layer coating comprising at least one compound with surface-active groups, selected from ionogenic surface-active groups, ionic surface-active groups, non-ionic surface-active groups or any combination thereof.

28. The composition according to claim 16, comprising at least one highly branched polymer comprising nitrogen atoms, having a degree of branching (DB) of 10% to 100%.

29. The composition according to claim 28, wherein the at least one highly branched polymer comprising nitrogen atoms has a degree of branching (DB) of 20 to 95%.

30. The composition according to claim 28, wherein the at least one highly branched polymer comprising nitrogen atoms has a degree of branching (DB) of 25 to 90%.

31. The composition according to claim 28, wherein the at least one highly branched polymer comprising nitrogen atoms has a degree of branching (DB) of 30 to 80%.

32. The composition according to claim 16, wherein the highly branched polymer b) comprises at least one highly branched polymer comprising at least one melamine group.

33. The composition according to claim 16, wherein the highly branched polymer b) comprises at least one highly branched polyurethane polymer.

34. The composition according to claim 16, wherein the highly branched polymer b) comprises at least one highly branched polyurethane polymer comprising at least one melamine group.

35. A method for the preparation of the microwave absorbing composition according to claim 16, wherein nanoparticles a) are mixed with at least one highly branched polymer comprising nitrogen atoms b).

36. A method for decreasing electromagnetic interference of electronic devices, computers, and telecommunication systems comprising utilizing the microwave absorbing composition according to claim 16.

37. A method for shielding cellular phone users from microwave radiation comprising utilizing the microwave absorbing composition according to claim 16.

38. A radiation absorber for controlling the radiation pattern in microwave antennae comprising the microwave absorbing composition according to claim 16.
